(19) United States
(12) Patent Application Publication
(10) Pub. No.: US 2007/0062019 A1
(43) Pub. Date: Mar. 22, 2007

(54) Assembly for joining structural components without welding

(75) Inventors: Michael Imparato, Longboat Key, FL (US); Adam Clark, Bradenton, FL (US); Conrado Hernandez, Parrish, FL (US)

Correspondence Address: LEVENFELD PEARLSTEIN;Intellectual Property Department, 2 North LaSalle, Suite 1300, CHICAGO, IL, 60602, US

(73) Assignee: Beacon Products Inc., Sarasota, FL (US)

(21) Appl. No.: 11/233,207

(22) Filed: Sep. 22, 2005

(51) Int. Cl. B25B 27/14; B23P 25/00

(52) U.S. Cl. 29/458; 29/464; 29/466; 29/467; 29/525.01; 29/281.5

(57) ABSTRACT

The disclosed assembly comprises a holding device assembly comprising a plurality of external face plates. The external face plates overlap at bolt joints so that the loading of the device bolts acts to secure the external face plates into a unitary structure that resists movement upon application of external load to the axis of a tubular member held thereby. In a preferred embodiment the external face plates are bolted to the base plate, which is secured to a foundation. The inventive holding device assembly is used for lamp posts and for related applications and is made of aluminum or steel.

### FIELD OF THE INVENTION

This invention relates to a method and structural assembly, hereinafter also termed “assembly,” for joining a tubular member comprising a metal tube, typically an aluminum tube, to a flat surface without welding wherein the resulting joint retains the yield strength of the materials of the structural assembly. The instant invention accordingly relates to a method and an assembly of structural parts comprising three or more overlapping external face plates joined to form a holding device comprising an external annular housing. The invented structural assembly accordingly comprises the holding device, three or more clamping bars, three or more side bolt washer plates, a washer plate, a base plate, a fluted or round metal tube, and associated metal bolts, nuts, washers, and O-rings.

The invention accordingly relates to base supports for tubular members comprising aluminum pole assemblies employed for street lighting and other illumination applications and provides a method and base support mechanism and structural assembly to allow use of aluminum poles, but does not require welding the pole to a base support. The structural assembly and resulting joint of the aluminum pole to a base support retains the strength of the joint components as compared to a welded joint. The method and structural assembly also avoids the use of steel support bolts threaded into aluminum screw threads tapped into an aluminum pole and thus avoids stripping the aluminum threads, but uses steel bolts as effective construction elements of the structural assembly for securing the aluminum pole to a base support.

### DESCRIPTION OF PRIOR ART

U.S. Pat. No. 5,499,885 to Chapman discloses an apparatus and method for joining structural components, including a tubular element or tube. U.S. Pat. No. 5,499,885 discloses two structural components wherein the first component has a shaft passageway therein, a coupling device placed within the passageway, a structural component of a plurality of members, and vertical bolts located at the interior of the shaft and passing through extruded corner pieces to secure the plurality of members into said components. The corner member pieces slide into each other to form a coupling device (102), which is then bolted to the base plate (160). An extruded washer plate is placed under the bolts, and a single washer plate goes under all bolts to retain internal components. Horizontal bolts secure the collar segment and connect corner pieces to the coupling device. The vertical bolts secure the assembly elements to lock the components into a unitary structure. The tubular element has the vertical bolts of the unitary structure inside the tubular element or tube. The tube shifts away from the base plate at a relatively low load level, which constrains the flexibility of the tube.

U.S. Pat. No. 4,793,111 to Shewchuk discloses an assembly for securing a pole to a base plate without using welding. A tubular member forms an extruded tube wall and a plurality of pairs of elongated rib members co-extruded with the tube wall to form arcuate grooves defining bores. Each of the bores is threaded. A threaded spindle is threadedly introduced into each bore of a base plate. A threaded nut fits over the end of the spindle and secures the pole to the base plate.

U.S. Pat. No. 3,894,375 to Lindberg discloses a metal tubular sleeve mounted in concrete to receive a tubular pole. A wedge within the sleeve is disposed against the outside of the pole to secure the pole within the pole base.

U.S. Pat. No. 2,952,484 to Zoltok discloses a tube connector for joining tubular lamp standards wherein a vertical tubular pole is joined by an internal tube connector to a cantilever arm extending from the top of the pole. The tube connector includes a junction tube that has its upper end welded to the inside of the lower end of the cantilever tube. The junction tube is split vertically to enable it to be expanded after insertion into the tubes it is joining. Two pairs of expansion blocks spaced apart inside the junction tube are held in spaced-apart position by opposed elongated straps. The straps are each welded to the inside of the junction tube. Expansion of the blocks is obtained by a screw threaded bolt. Each pair of the expansion blocks is independently expandable. The connection of the junction tube to the lower end of the cantilever tube is by welding.

U.S. Pat. No. 3,437,362 to Offenbroich discloses an expansion device for joining tubular elements used for erecting display assemblies, scaffolding, shelving, and the like. Expansion is obtained by advancing a screw with a specially machined forward end, which engages in cam fashion three other parts to expand all four parts away from each other to engage the structural member. There is no means for securing the expanded members together in their wall contact position into a unitary structure. While this structure could be suitable for shelving and the like, it would not be useful for installations with constantly changing loading such as wind loading. This structure does not have any formation for wire passages through the expansion device in those instances where needed.

U.S. Pat. No. 4,318,629 to Yamamoto discloses a coupling apparatus with a clamp member that can be advanced by a screw to engage the inner wall of a tubular frame member to bring the opposing inner wall of the frame member against the clamp member support. There is no provision for securing the clamp mechanism into a unitary structure to maintain its wall-engaging contact.

U.S. Pat. No. 3,653,169 to Jenner discloses a mounting arrangement for building modules comprising square or rectangular sockets extending upwardly from a base mounting plate to receive a correspondingly shaped hollow column. Wedge-shaped shoes expandable within the inside of the hollow columns are moved to contact the column walls. The rectangular sockets are welded to the base mounting plate. The building modules have already installed plumbing, electrical, and other facilities.

The prior art teaches a number of methods and structures to join structural components and to connect a tubular component as a pole to a flat surface, in some cases, without welding. The pole applications can require the shaft to be stressed by environmental wind stress on occasion near its yield strength. In addition, the assembly must withstand repetitive (fatigue) loading over the course of its service life. The prior art devices are designed for applications less demanding than the applications for which the claimed assembly is designed.

In the instant invention, the assembly comprises a holding device comprising an external annular housing of rounded external face plates joined to form a holding device of the aluminum pole supported thereby. The holding device resultant comprising an external annular housing of the joined face plates provides four tubular shafts for insertion of steel bolts to anchor the holding device to a base plate. High-strength steel bolts are preferred. In use, the instant invented structural assembly requires the insertion of U-shaped clamping bars within the aluminum pole held by the holding device. The U-shaped internal clamping bars are of aluminum, to avoid the use of a steel material in direct contact with the aluminum pole, and thus avoid electrolytic action from dissimilar metals. The aluminum U-shaped internal clamping bars are placed within the structure of the aluminum pole and thus contact the aluminum pole. Each U-shaped internal clamping bar has a rounded exterior surface and an opposite flat surface between two U-shaped arms. Each internal clamping bar receives thereon, between the two U-shaped arms, a side bolt washer plate of galvanized steel, galvanized to avoid galvanic action. Each internal clamping bar and each bolt washer plate has bolt holes located to agree with bolt holes located in the aluminum pole. Steel bolts, preferably galvanized, inserted in the bolt holes serve to secure the assembly to the aluminum pole. Likewise, four steel bolts, preferably galvanized, serve to secure the assembly to the base plate. The galvanized base plate provides structural support for the aluminum pole. The base plate with the attached structural assembly and secured aluminum pole supported thereby is suitably attached to the support foundation or other external support structure.

Accordingly, in the instant invention, the structural assembly comprises a holding device comprising an external annular housing shaped from rounded external face plates joined to form the holding device. The rounded face plates overlap at each of one of the rounded sides. U-shaped internal clamping bars situated within the aluminum pole are employed to clamp the holding device comprising the rounded face plates to the aluminum pole. Galvanized side bolt washer plates fit within the U-shaped arms of the clamping bars to receive clamping means consisting of steel nuts and bolts. The steel bolts are inserted through bolt holes in the rounded face plates, through bolt holes in the aluminum pole, through bolt holes in the clamping bars, and through bolt holes in the galvanized side bolt washer plates. The steel bolts secure the joining of the structural assembly to the aluminum pole by nuts seated on the galvanized facing of the galvanized side bolt washer plate.

A washer plate with four bolt holes is mounted atop the holding device over the four tubular shafts of the holding device. Steel bolts inserted therein serve to anchor the holding device to the base plate. The load on the anchor bolts caused by bending of the supported aluminum poles acts to form the face plates of the holding device into a unitary structure that resists bending movement. This form of bending load is commonly experienced by street lighting poles.

There are a number of applications where the structural assembly of this invention can be used as a connecting device or otherwise attached to another part such as a base. For example, vertical building modules can use hollow vertical tubular construction columns that have their lower ends connected to a base. Further, in a building application, tubular construction components can be used as beams, which again require tubular joining methods and tubular joining apparatus. If the tubular construction components are formed from aluminum, then important weight reductions can be achieved, which translate directly into increased payloads and then improved profits.

This invented assembly is particularly suitable for use in utility pole assemblies for street and highway lighting and as electric wire carriers.

The utility poles may be of any material that is suitable for the intended application, e.g., steel, aluminum or other materials. Most of these poles are elongated and tubular. Aluminum is very popular because of its lightweight and corrosion-resistant qualities.

A common method of attaching a tubular pole is to weld the lower end of the pole to a base plate, which is connected to an anchor structure. Welding causes a loss of temper and yield strength. Yield strength of a utility pole of aluminum type 6063-T6 can be 25,000 psi. Welding can decrease the loading capacity of the pole by as much as 57 percent. Therefore, it is preferable to mechanically fasten the pole to a base plate to retain the yield strength and loading capacity. A utility pole fastened thereby can weigh less and be less expensive but have the same loading capacity as a larger and more expensive pole attached to a base support by welding, wherein the quality of a weld can vary.

It is known in the prior art to use a mechanical fastening method, which employs a fixed-size inner sleeve, which fits the tubular pole. The inner sleeve can be attached to a base plate with provision for attaching the base plate to an anchor. The problem in this method is to control the tolerance of fitting the fixed-size inner sleeve within the internal sides of the tubular pole. To have a stable connection, the tolerance between the sleeve and the internal sides of the tube must be very close. The desired tolerance can be different to maintain in the manufacturing process without adding considerable expense to the process. The die for the desired shape and form of the tube can wear out and change dimensions.

When the fixed-size inner sleeve is too small, the pole fit with the inner sleeve can be loose; a hinge effect can occur. This not only reduces the initial load capacity but permits additional reductions in capacity if the pole metal becomes fatigued by pole motion. If the inner sleeve is too large and is jammed into the tube inner sides, a shearing or fracturing problem may occur. In any event, the forcing into the pole of an oversized inner sleeve can stress the pole and cause a rupture or hairline crack.

While this invention is particularly well suited for and advantageously used with tubular poles, protection is sought for applications of the invention wherein the invention may be used, including those discussed above and hereinafter.

It is an object of the invention to provide a non-welded, aluminum structural assembly to support street light lamp poles, the structural assembly comprising an externally attached mechanical device.

It is an object of the invention to provide a structural assembly comprising a holding device to connect a tubular member or tube to a flat surface without welding wherein the connecting joint develops enough strength to approach the mill strength of the materials of the holding device.

It is an object of this invention to provide a joint assembly having a yield strength that meets or exceeds AASHTO Code requirements. It is a further object to provide a joint assembly having a yield strength of the materials of the assembly in the range of from 30,000 psi to 40,000 psi, preferably having a psi of at least 35,000, and an ultimate strength of the materials of the assembly in the range of from 35,000 psi to 45,000 psi. The yield strength of the materials refers to a point at which material begins to deform beyond a certain level. The ultimate strength of the material is the breaking point. These data are particularly applicable for 6061-T6 aluminum extrusions.

A further object is to provide a structural assembly, in combination, comprising a holding device of a plurality of external face plates. The structural assembly further comprises internal clamping bars, side bolt washer plates, and related bolts and nuts, said external face plates of the holding device overlapping such that loading of said holding device acts to form said external face plates into a unitary structure that resists movement upon application of external load normal to the axis of the holding device. Anchor bolts secure the annular housing of a plurality of face plates to the base plate.

It is therefore an object of this invention to provide a structural assembly, in combination, comprising:
(a) a tubular member,
(b) a holding device comprising a plurality of external face plates to form an external annular housing around said tubular member,
(c) the tubular member comprising a plurality of bolt means of attachment comprising bolt holes,
(d) the holding device shaped from the external face plates to receive said anchor bolts in said face plates, said external face plates overlapping at the bolt joints, so that the loading stress of the bolts acts to form the external face plates into a unitary structure that resists movement upon application of an external load normal to the axis of the tubular member,
(e) internal clamping bars,
(f) side bolt washer plates,
(g) bolts and nuts to secure said internal clamping bars to said external face plates and secure said tubular member in position,
(h) a base plate, and
(i) said anchor bolts to bolt said holding device to the base plate.

In a preferred assembly, galvanized steel bolts are employed wherein the bolts are seated on a circular washer plate to add lateral stability. Additionally, additional bolts can be employed to attach to the clamping bars above the top of the face plates of the holding device to provide a cross-section transition and reduce stress on the holding device. In general, the holding device is of aluminum. Adhesive is optionally applied between the bolt and nuts to resist loosening.

Another object of this invention is to provide a method to join a metal pole or tubular member to a flat surface without welding, developing strength in the holding joint to meet AASHTO Code requirements, based on the materials of the joint, to provide a yield strength in the range of from 30,000 psi to 40,000 psi, preferably at least 35,000 psi, and to have an ultimate strength in the range of from 35,000 psi to 45,000 psi, said method comprising:
(a) clamping the metal pole (tubular member) to a holding device using bolts through the external face plates, the bolts between the external face plates and internal clamping bars with side bolt washer plates inserted therein the internal clamping bars,
(b) bolting the holding device to a base plate,
(c) attaching the base plate to a foundation to join the metal pole (tubular member) to a flat surface, and
(d) loading of the bolts to form the face plates into a unitary structure as a holding device as an annular housing that resists movement upon application of external load normal to the axis of the metal pole.

Another object is to provide a method wherein the bolts pass through a washer plate and the face plates to add lateral stability to the structural assembly and to increase assembly stiffness. Advantageously, adhesive is applied between the bolts and nuts to resist the loosening of the external fastening. A further object is a method for securing a metal pole to a flat surface using face plates and clamping bars, the method comprising clamping the metal pole between external face plates and internal clamping bars. A further object is to use high-strength bolts for securing the holding device.

Further objects include the method wherein the bolt passes through a circular washer plate to add lateral stability to the assembly. Another object of the invention includes the method of assembling the inventive assembly wherein adhesive is applied between the bolts and nuts to resist loosening of the external fastening.

In view of the above objects, the present invention relates to a structural assembly to join a metal tube to a flat surface without welding wherein the assembly of structural parts comprises, in combination, a holding device of a plurality of three or more overlapping external face plates, which in joint association provide a plurality of attachment and anchor bolt holes for insertion of anchor bolts to secure said holding device to a base plate, a circular washer plate to engage said anchor bolts to said holding device, a plurality of three or more internal clamping bars for insertion within said metal tube to secure said metal tube to said holding device by attachment bolts inserted through said holding device and said metal tube, wherein said attachment bolt nuts of attachment bolts are seated on galvanized side bolt washer plates on the inner side of each of the plurality of internal clamping bars. In a preferred embodiment, the holding device comprises four overlapping external face plates and four internal clamping bars.

This invention accordingly is an assembly comprising a holding device for joining a metal tube to a flat surface, the assembly suitably made from aluminum, though steel can be used, attachable to a flat surface without welding, and having enough strength in the joint to approach the mill strength of the materials of the holding device. An important advantage of the assembly is that the joint is not welded. Materials such as aluminum are weakened by welding.

The assembly holding device of this invention is designed to meet or exceed the yield strength specified by the AASHTO Code for 6061 T6 aluminum extrusions. The structural assembly holding device of this invention is designed to have a yield strength in the range of from 30,000 psi to 40,000 psi, preferably having a psi of at least 35,000. The designed ultimate strength of the unwelded aluminum structural assembly holding device of this invention is in the range of from 35,000 psi to 45,000 psi.

The invented assembly holding device is used in securing shafts of aluminum lighting, signage, and structure poles. The assembly holding device alternatively can be made from steel or stainless steel.

The assembly holding device of this invention is designed to provide greater strength needed for a specific shaft size than can be provided by a welded pole, as well as when a direct burial pole is not suitable.

The assembly holding device of this invention provides for applications where weld fatigue is a problem. When aluminum is welded, any temper is relieved and the material is weakened. An example is the welding of a pole to its base. The strength of 6061-T6 aluminum is reduced from 35,000 psi to 20,000 psi yield strength according to the 2001 AASHTO standard. Welds also introduce residual stresses and they are relatively brittle, both of which are further physical parameters promoting fatigue of the joint.

This invention provides a structural assembly holding device for securing poles of various pole heights, various pole loadings (projected “sail” area of fixtures, signage, etc.) and various environmental wind pole loadings that preclude welded poles from consideration for the desired size. The prior art has used direct burial poles, but these are sometimes impractical as direct burial poles may not be removable or replaceable. An option is to increase pole diameter for increased load. This may require a large, decorative base, which may be substantially more expensive than the assembly holding device of this invention and may not meet aesthetic criteria set by governmental bodies or other owners. The assembly holding device of this invention is designed to enable the anchor-based holding device of a given shaft size to support additional load. As a result of utilizing this inventive assembly holding device, the holding device may hold taller poles, or poles may carry luminaries, arms, and signage with greater sail area (EPA), giving users greater flexibility and utility. Alternatively, a smaller diameter pole shaft, which is less expensive, may suitably be used for a predetermined configuration.

An advantage of this inventive assembly is that the structural assembly holding device of this invention and secured pole is easier to install than a direct burial pole, since the structural assembly holding device of this invention and pole are attached to an anchor base.

The inventive assembly holding device advantageously does not require a welded aluminum joint to be heat treated. Heat treatment does not usually restore the full strength of the weld.

A prior art method provides that the tube be bolted through its sides to an internal nested sleeve to connect to the base plate. The instant structural assembly holding device utilizes multiple external interlocking plates and is therefore not dependent on the especially fine tolerances required by the prior art device.

In the structural assembly holding device of this invention, the structural assembly holding device comprises bolts and external face plates. The external face plates overlap at the bolt joints so the loading of the bolts acts to secure the face plates into a unitary structure that resists movement upon application of external load normal to the axis of the holding device.

The external face plates are bolted to a flat plate (a base plate), which is attached to the foundation or external support. The bolts suitably pass through a washer plate atop the annular housing to add lateral stability to the assembly. The washer plate can be optional.

The internal clamping bars can extend above the top of the external face plates comprising the external annular housing and attach to the metal tube to provide a smoother cross-sectional transition and reduced stress.

The number of face plates, internal clamping bars, and bolt assemblies required can be adjusted as required for a particular application. In a preferred embodiment four face plates, clamping bars, washer plates, and bolts are utilized.

### SUMMARY OF THE INVENTION

A structural assembly is disclosed for joining a metal tube to a support surface wherein the structural assembly comprises a first component comprising a holding device comprising an external annular housing of joined overlapping face plates around the metal tube to form the external annular housing, a second component comprising internal clamping bars and side bolt washer plates placed within the metal tube, a third component comprising a washer plate and associated nuts and bolts, which anchor the holding device to a fourth component comprising a base plate support surface. In a preferred embodiment, a plurality of joined face plates, four in number, are used with each of the face plates having a wall portion with an opposing wall portion of the immediately next overlapping face plate, the joined face plates held in place against the metal tube by inserted bolts through the external face plate vertical sides, with internal clamping bars, and side bolt washer plates.

### BRIEF DESCRIPTION OF THE DRAWINGS

FIG. 1 illustrates the structural assembly and joined metal tube section.

FIG. 2 illustrates the assembled external face plates, the washer plate and bolts, and base plate.

FIG. 3 illustrates the washer plate with the vertical bolts and washers.

FIG. 4 illustrates the U-shaped internal clamping bars.

FIG. 5 illustrates the side bolt washer plates, which fit within the U-shaped internal clamping bars.

FIG. 6 illustrates the individual face plates.

### DETAILED DESCRIPTION OF THE INVENTION

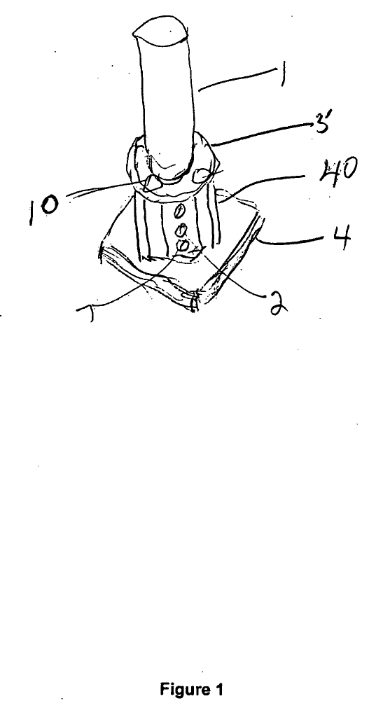

FIG. 1 illustrates the structural assembly and components thereof and joined metal tube (1) held in position by the structural assembly. The washer plate (5) encircles metal tube (1) and is held in place by bolts (10) atop the external annular housing (40) formed by face plates (2). Bolts (10) project through the joined face plates (2) to attach the structural assembly comprising washer plate (5), assembled face plates (2) to the base plate (4). Bolts (7) project through external annular housing (40) of face plates (2) through bolt holes (not shown) of metal tube (1), of U-shaped clamping bars (3) (not shown), and of side bolt washer plates (6) (not shown).

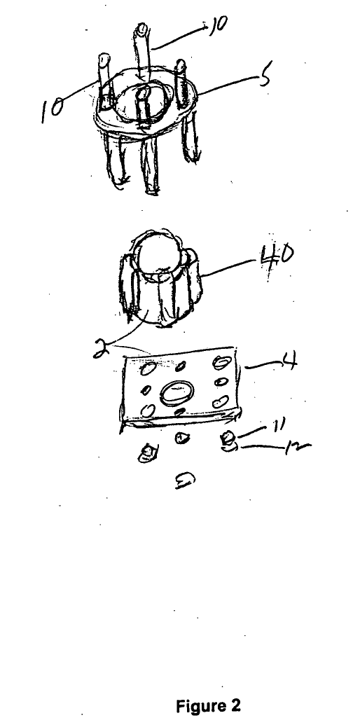

FIG. 2 illustrates the assembled face plates (2) to form external annular housing (40), the washer plate (5) with inserted bolts (10) in position for assembly to base plate (4), washers (11), and nuts (12).

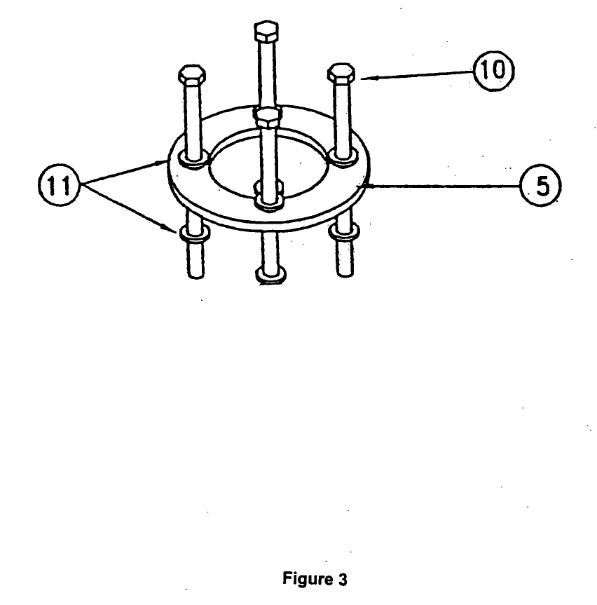

FIG. 3 illustrates washer plate (5), bolts (10), and washers (11).

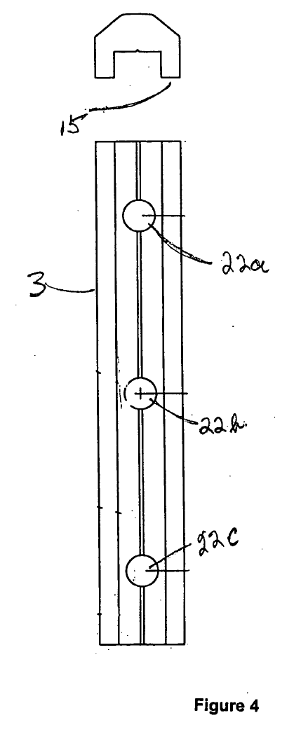

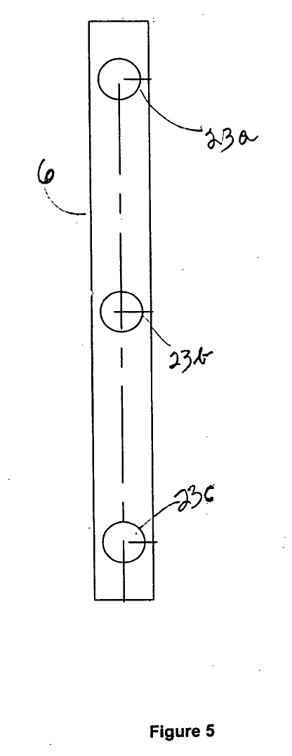

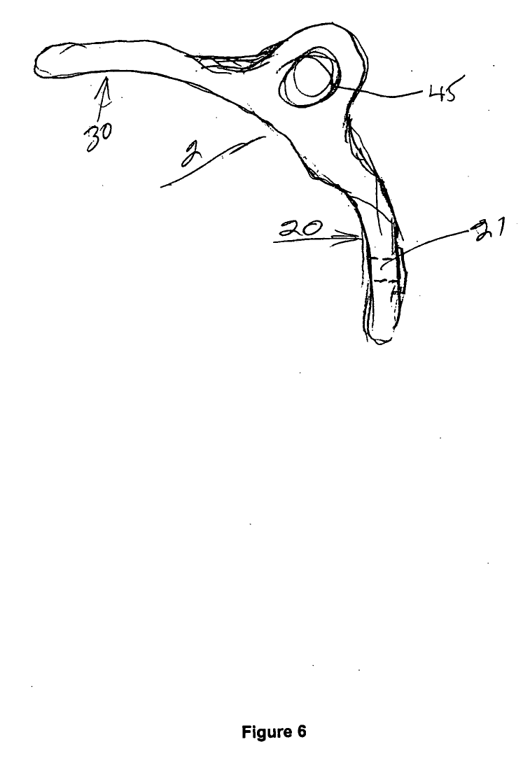

FIGS. 4-6 illustrate individual components of the structural assembly, which retain the joined metal tube in position. FIG. 4 illustrates the U-shaped internal clamping bar (3) with U-shaped arms (15), which receives and encloses the side bolt washer plate (6), in position, illustrated in FIG. 5. FIG. 6 illustrates design of an individual face plate (2) which form the annular housing (40). One side of each face plate (2) has a rounded indentation 20 sufficient to receive the rounded edge (30) of an intersecting face plate (2) to form annular housing (40) of a plurality of face plates (2).

In operation, the metal tube (1) is inserted within the washer plate (5). Bolts (10) affix the washer plate (5) on the external annular housing (40) formed by the intersecting face plates (2). Bolts (10) project through annular bores (45) of individual face plates (2) to secure the annular housing (40) to base plate (4). The washer plate (5) can be segmented of separate components to place around the metal tube (1) to accommodate tube diameters of different tubular members.

Bolt holes (not shown) in metal tube (1) receive bolts (7) inserted through bolt holes (21) in face plates (2), bolt holes (22a, 22b, 22c) in clamping bars (3), bolt holes (23a, 23b, 23c) in retained side bolt washer plates (6) within the U-shaped arms (15) of clamping bars (3) positioned within metal tube (1) to receive bolts (7). Washers (8) (not shown) and metal nuts (9) (not shown) engage bolts (7) at the inserted end of bolts (7) within metal tube (1) to secure metal tube (1) to annular housing (40).

The structural assembly and joined metal tube (1) in FIG. 1 illustrates application to a tube having convex sections or a tube suitably smooth (completely round). The structural assembly can be made of aluminum, though steel, stainless or otherwise, can be used in applications where desired.

The metal tube (1) is clamped using high-strength bolts (not shown) between external face plates (2) of external annular housing (40) shown in FIG. 1 and clamping bars shown in FIG. 4. In the embodiment shown in FIG. 2, four external face plates (2) are used. The number of face plates can be three, four, five, six, or more. The external face plates (2) overlap at rounded indentation (20) and bolt holes (21) at bolt joints so that the loading of the bolts acts to secure the external face plates (2) into a unitary holding device annular housing (40) that resists movement upon application of an external load normal to the axis of the holding device annular housing. The external face plates (2) comprising the external annular housing are bolted by bolts (10) to the base plate (4) shown in FIG. 1, which is attached to the foundation or external support structure (not shown). The bolts pass through a washer plate (5) shown in FIG. 2. In FIG. 3 are also shown hex head bolts (10) and washers (11).

A series of tests were performed to determine resistance of the structural components of the invention to stress. Table 1 shows the displacement of a test pole of specific height from initial permanent set position upon application of an applied stress load applied to the test pole at the height specified. The test pole is held at the base by the invented structural assembly.

TABLE 1
Displacement of Pole From Fixed Elevation Point Under Applied
Load, Pole Positioned in Invented Structural Assembly

| Applied Load | Load Applied at | Displacement |
|---|---|---|
| (lb.) | Height of Pole (in.) | (in.) |
| 0 | 21.5 | 0 |
| 60 | 21.4375 | −0.0625 |
| 200 | 21.5 | 0 |
| 400 | 21.875 | 0.375 |
| 560 | 22.15 | 0.65 |
| 700 | 22.4 | 0.9 |
| 800 | 22.6875 | 1.1875 |
| 900 | 23 | 1.5 |
| 1000 | 23.375 | 1.875 |
| 1100 | 24 | 2.5 |
| 1180 | 24.625 | 3.125 |
| 5 hrs | 24 | 2.5 |
| after test | | |
| 51 hrs | 23 | 1.5 |
| after test | | |

The foregoing description is of specific embodiments of the present invention. It should be appreciated that these embodiments are described for purposes of illustration only and that numerous additions and modifications may be practiced by those skilled in the art without departing from the spirit and scope of the invention. It is intended that all such modifications and alterations be included insofar as they come within the scope of the invention as claimed or the equivalent thereof.

What is claimed is:

1. An assembly for joining a tubular member comprising a metal tube to a flat surface, in combination, comprising:
(a) a tubular member,
(b) a holding device having an axis comprising axis of said tubular member,
(c) said holding device comprising a plurality of external face plates to form an external annular housing around said tubular member,
(d) said holding device comprising a plurality of anchor bolts,
(e) said holding device shaped to receive the anchor bolts through said external face plates, said external face plates overlapping at bolt joints, so that loading of said anchor bolts acts to secure said external face plates into a unitary structure that resists movement upon application of an external load normal to the axis of said holding device,
(f) U-shaped internal clamping bars,
(g) side bolt washer plates,
(h) a washer plate,
(i) a base plate,
(j) bolts and nuts which secure said internal clamping bars and side bolt washer plates to said external face plates and secure said tubular member in position, and
(k) the external face plates bolted to the base plate by said anchor bolts.

2. The assembly of claim 1 wherein said anchor bolts pass through said washer plate to add lateral stability and increase assembly stiffness.

3. The assembly of claim 1 wherein side bolt washer plates and base plate are galvanized metal.

4. The assembly of claim 1 wherein U-shaped arms of U-shaped internal clamping bars receive and enclose said side bolt washer plates in position.

5. The assembly of claim 1 wherein said washer plate is segmented of separate components to accommodate different diameters of said tubular member.

6. The assembly of claim 1 wherein the holding device is made of aluminum.

7. The assembly of claim 1 wherein the holding device is made of steel.

8. The assembly of claim 1 wherein said tubular member comprises an aluminum tube.

9. The assembly of claim 1 wherein said tubular member comprises a steel tube.

10. The assembly of claim 1 wherein adhesive is applied between bolts and nuts to resist loosening.

11. The assembly of claim 1 wherein high-strength bolts are employed.

12. An assembly to join a tubular member comprising a metal tube to a flat surface attached to an external support structure, in combination, comprising:
(a) a holding device,
(b) said holding device comprising a plurality of external face plates forming an external annular housing around said tubular member,
(c) said holding device comprising a plurality of U-shaped internal clamping bars,
(d) a plurality of side bolt washer plates engaged within arms of said plurality of U-shaped internal clamping bars,
(e) said holding device comprising a plurality of high-strength anchor bolts,
(f) said holding device comprising external face plates secured to internal clamping bars by high-strength bolts, said external face plates overlapping at bolt joints, so that the loading of said bolts acts to secure the external face plates into a unitary structure that resists movement upon application of an external load normal to the axis of said tubular member, said high-strength bolts engaging said tubular member in position between said external face plates, U-shaped internal clamping bars, and side bolt washer plates within arms of U-shaped clamping bars,
(g) a base plate,
(h) the external face plates forming said external annular housing bolted to the base plate by said anchor bolts,
(i) a foundation support structure, and
(j) said base plate secured to said foundation as an external support structure.

13. The assembly of claim 12 wherein anchor bolts pass through a washer plate to add lateral stability and increase assembly stiffness.

14. The assembly of claim 12 wherein said tubular member is selected from the group consisting of aluminum tubes and steel tubes.

15. The assembly of claim 12 wherein U-shaped internal clamping bars extend above the top of the external face plates comprising the external annular housing and attach to said tubular member to provide a cross-section transition and reduce stress on said tubular member.

16. The assembly of claim 12 wherein the holding device is made of aluminum.

17. The assembly of claim 12 wherein the holding device is made of steel.

18. The assembly of claim 12 wherein adhesive is applied between bolts and nuts to resist loosening.

19. A method for joining a tubular member to a flat surface without welding using an assembly comprising a holding device comprising external face plates to hold said tubular member and developing enough strength in the joint to meet AASHTO Standards said method comprising:
(a) providing bolt holes in said tubular member to receive bolts through said external face plates, which form an external annular housing around said tubular member, said bolts to secure said annular housing to said tubular member,
(b) bolting the external annular housing comprising said external face plates with attachment bolts to a base plate,
(c) attaching the base plate to a foundation as an external support, and
(d) loading of said attachment bolts, which acts to secure said face plates forming said annular housing into a unitary structure that resists movement upon application of an external load normal to the axis of said tubular member.

20. The method of claim 19 wherein said bolts pass through a washer plate and said annular housing to add lateral stability and increase assembly stiffness to the assembly.

21. The method of claim 19 wherein adhesive is applied between bolts and nuts to resist the loosening of external fasteners.

22. The method of claim 19 wherein the yield strength of the materials in the resulting joint is in the range of from 30,000 psi to 40,000 psi.

23. The method of claim 22 wherein the yield strength of the materials in the resulting joint is at least 35,000 psi.

24. The method of claim 19 wherein the ultimate strength of the materials in the resulting joint is in the range of from 35,000 psi to 45,000 psi.

25. A method for securing a tubular member to a flat surface without welding and developing enough strength in the joint to meet AASHTO Standards said method comprising:
(a) clamping the tubular member between external face plates of a holding device and internal clamping bars with side bolt washer plates inserted therein,
(b) bolting the external face plates of said holding device to a base plate with attachment bolts, and
(c) attaching the base plate to foundation, and
(d) loading said attachment bolts, which acts to secure the face plates of said holding device into a unitary structure that resists movement upon application of an external load normal to the axis of the tubular member.

26. The method of claim 25 wherein the bolts pass through a washer plate atop said external face plates to add lateral stability and assembly stiffness to the assembly.

27. The method of claim 25 wherein an adhesive is applied between bolts and nuts to resist the loosening of external fastening.

28. The method of claim 25 wherein design yield strength in the resulting joint is in the range of from 30,000 psi to 40,000 psi.

29. The method of claim 28 wherein design yield strength of the resulting joint is at least 35,000 psi.

30. The method of claim 25 wherein design ultimate strength in the resulting joint is in the range of from 35,000 psi to 45,000 psi.

31. An assembly, in combination, comprising:
(a) a tubular member,
(b) a holding device,
(c) the holding device having a plurality of clamping bars,
(d) the holding device having a plurality of high-strength bolts,
(e) the holding device having a plurality of external face plates, and
(f) the tubular member clamped between the external face plates and internal clamping bars by the bolts, said external face plates overlapping at bolt joints, so that loading of the bolts acts to secure the external face plates into a unitary structure that resists movement upon application of an external load normal to the axis of the tubular member.

32. The assembly of claim 31 wherein the holding device is made of aluminum.

33. The assembly of claim 31 wherein the holding device is made of steel.

34. The assembly of claim 31 comprising nuts.

35. The assembly of claim 31 wherein adhesive is applied between bolts and nuts.

36. A method for joining a holding device and a tubular member to a flat surface without welding, wherein the resulting joint retains yield strength of the materials in the joint in the range of from 30,000 to 40,000 psi, said method in combination comprising:
(a) clamping the tubular member between external face plates and internal clamping bars of said holding device with bolts,
(b) attaching said holding device and clamped tubular member to a base plate with attachment bolts, and
(c) loading of attachment bolts, which acts to secure the external face plates into a unitary structure that resists movement upon application of an external load normal to the axis of the holding device.

37. The method of claim 36 wherein said attachment bolts pass through a washer plate to add lateral stability to the assembly.

38. The method of claim 36 wherein an adhesive is applied between bolts and nuts to resist the loosening of external fastening.

39. The method of claim 36 wherein design yield strength is at least 35,000 psi.

40. The method of claim 36 wherein design ultimate strength in the joint is in the range of from 35,000 psi to 45,000 psi.
